(19) United States
(12) Patent Application Publication
(10) Pub. No.: US 2016/0011633 A1
(43) Pub. Date: Jan. 14, 2016

(54) ELECTRONIC DEVICE

(71) Applicant: SHARP KABUSHIKI KAISHA, Osaka-shi, Osaka (JP)

(72) Inventors: Hisashi WATANABE, Osaka (JP); Tomohiro KIMURA, Osaka (JP)

(73) Assignee: Sharp Kabushiki Kaisha, Osaka (JP)

(21) Appl. No.: 14/773,217

(22) PCT Filed: Feb. 27, 2014
(86) PCT No.: PCT/JP2014/054966

§ 371 Date: Sep. 4, 2015

(30) Foreign Application Priority Data
Mar. 15, 2013 (JP) 2013-053651

(51) Int. Cl. G06F 1/16; G02F 1/1333; G09G 3/36

(52) U.S. Cl. CPC G06F 1/1684; G09G 3/3648; G02F 1/133308

(57) ABSTRACT

An electronic device includes: a display panel having a substrate, the display panel having a display area on the substrate, a frame region on the substrate outside the display area, and a hole that penetrates the substrate within the display area, display being inhibited in a portion of the display area that surrounds the hole; an input device disposed on one side of the substrate and having a section protruding from the display panel, the input device being disposed in a location corresponding to the hole; and a circuit substrate on another side of the substrate. The input device is connected to the circuit substrate via the hole in the display panel.

### TECHNICAL FIELD

The present invention relates to an electronic device having a display panel.

### BACKGROUND ART

Transmissive liquid crystal display devices usually include a liquid crystal panel, backlight device, a circuit board or power supply for supplying various types of electrical signals to the liquid crystal panel, a case for housing these, and the like.

The liquid crystal panel has a display area (active area) in which a plurality of pixels are arrayed, and a frame region (non-active area) outside the display area. The display area has pixel electrodes, TFTs, and the like, and displays images or video. Meanwhile, the frame region has a sealing member for sealing liquid crystal material between substrates, wiring or a monolithically-formed driver circuit connected to scan lines or signal lines, terminals that connect to an external driver circuit, and the like. The frame region is not used for image or video display.

The frame region of the liquid crystal panel does not contribute to display, and it is therefore preferable that the frame region be made narrow. Yet, while the frame region of liquid crystal panels has been progressively narrowed over the years, completely eliminating the frame region is difficult in principle.

Conventional research has focused on narrowing or obscuring the frame region on the display panel. The subject applicant has disclosed in Patent Document 1 a display device in which a transmissive cover is disposed on the viewer's side of the display panel. In this display device, the edge of the transmissive cover has a convex curved portion that function as a lens.

The convex curved portion (lens portion) of the transmissive cover is typically disposed so as to cover the frame region of the display panel and a part of the display area near the frame region (hereinafter, also referred to as the “peripheral display area”). The light emitted from the pixels (peripheral pixels) in the peripheral display area refract at the lens portion, which results in the image formed by the peripheral pixels being magnified and displayed on the front side of the frame region. This gives the appearance to the viewer that the image is also being displayed on the frame region, which obscures the frame region or makes it seem as if the frame region does not exist.

It should be noted that attempting to obscure the frame region in this way pertains not only to liquid crystal display devices, but also to organic EL display devices, electrophoretic display devices, and the like.

By using the display device described above, it is possible to provide a portable electronic device (smartphone, etc.) in which almost the entire viewer's side panel surface of the electronic device is capable of display, for example. This type of electronic device has a large area capable of content display relative to its size, and is thus advantageous in terms of making the device more compact. Furthermore, such an electronic device exhibiting this neo-futuristic style could attract a wide audience.

### RELATED ART DOCUMENTS

### Patent Documents

Patent Document 1: WO 2010/089998

Patent Document 2: Japanese Patent Application Laid-Open Publication No. 2005-46352

Patent Document 3: Japanese Patent Application Laid-Open Publication No. 2009-47902

Patent Document 4: Japanese Patent Application Laid-Open Publication No. 2004-329694

### SUMMARY OF THE INVENTION

### Problems to be Solved by the Invention

As described above, there are attempts to use for display the entire viewer's panel surface (panel front surface) of an electronic device having a display panel. Depending on how the electronic device is used, however, it may be preferable to have physical/electrical switches (buttons) for receiving input from the user; optical devices such as a camera or optical sensor; an audio device such as a microphone; or the like on the surface of the device. The buttons or camera are arranged on the outside of the display panel, such as in the frame region, in conventional electronic devices. Accordingly, an electronic device that is designed so as to eliminate the frame region as described above faces problems such as how to arrange the buttons or the like.

If prioritizing a narrower frame region, the button switches could be provided on the back or sides of the electronic device, for example, rather than the front. Alternatively, a touch panel could be provided on the entire viewer's side panel surface, and the touch panel could assume the functions of the button switches, thereby eliminating physical switches from the panel front surface. This makes it possible to maximize the size of the display area.

Research performed by the inventors of the present invention, however, shows that the configuration described above may not be sufficiently convenient for the user. Furthermore, arranging button switches or a device such as a camera on the frame region in a conventional manner makes it difficult to provide a wide display-capable area on the panel surface of the electronic device. In addition, there were problems in which cameras or the like deviated in position relative to the display area, which caused it to be hard to make eye contact, particularly when video conferencing, etc.

The present invention was made in view of the above-mentioned problems, and an aim thereof is to provide an electronic device having a display panel in which the area of the panel front surface capable of being used for display can be expanded without hindering user-friendliness.

### Means for Solving the Problems

In an embodiment of the present invention, an electronic device includes: a display panel having a substrate, the display panel having a display area on the substrate, a frame region on the substrate outside the display area, a hole that penetrates the substrate in an area defined by the frame region, and a non-display area around the hole; an input device disposed on one side of the substrate and having a section protruding from the display panel, the input device being disposed in a location corresponding to the hole; and a circuit substrate on another side of the substrate, wherein the input device is connected to the circuit substrate via the hole in the display panel.

In one embodiment, the input device at least partially covers the non-display area formed around the hole.

In one embodiment, a separate wiring region having a different wiring pattern from other regions is formed around the hole; the non-display area includes the separate wiring region; and the input device at least partially covers the separate wiring region.

In one embodiment, the electronic device further includes a transmissive cover that covers at least a portion of the display panel, and the transmissive cover includes a lens section having a curved surface around the hole.

In one embodiment, the transmissive cover covers at least the area around the hole in the display panel and has a separate lens portion in an area corresponding to the end of the display panel.

In one embodiment, the display panel has a pair of substrates and a display medium layer held between the pair of substrates, and a sealing member for sealing the space between the pair of substrates is provided in the non-display area formed around the hole.

In one embodiment, the input device has a first portion that is larger than the hole and that protrudes from the viewer's side surface of the display panel, and a second portion that is linked to the first portion and that is disposed inside the hole.

In one embodiment, the electronic device further includes an image processing unit that generates image data supplied to the display panel, and the image processing unit can generate image data to cause an image related to the input device to be displayed around the input device.

In one embodiment, the images related to the input device are images for operating the input device.

In one embodiment, the input device can receive direct operation from the user, and a signal is supplied to the circuit substrate in accordance with the operation of the user.

In one embodiment, the input device includes a light-receiving device.

In one embodiment, the input device includes an imaging device and a fiber optic faceplate behind the imaging device.

In one embodiment, the fiber optic faceplate has a tapered shape, and an area of an end face of the faceplate on the viewer's side of the display panel is greater than an area on another end face of the faceplate.

In one embodiment, the display panel is a liquid crystal display panel.

### Effects of the Invention

An electronic device according to embodiments of the present invention makes it possible to obtain a display-capable area that is large relative to the size of the device without lowering user-friendliness.

### BRIEF DESCRIPTION OF THE DRAWINGS

FIG. 1 is a view for explaining an electronic device according to Embodiment 1 of the present invention; FIG. 1(a) is a plan view from the viewer's side, and FIG. 1(b) is a cross-sectional view along the line x-x′ of FIG. 1(a).

FIG. 2 is a view for explaining an electronic device according to a comparison example of the present invention; FIG. 2(a) is a plan view from the viewer's side, and FIG. 2(b) is a cross-sectional view along the line x-x′ of FIG. 2(a).

FIG. 3 is a cross-sectional view showing a magnified part of the electronic device in FIG. 1(b).

FIG. 4 is an in-use view of the electronic device of Embodiment 1; FIG. 4(a) shows a case in which the input device is a push-button, and FIG. 4(b) shows a case in which the input device is a rotary switch.

FIG. 5 is a view for explaining forms for displaying images that are linked with the input device; FIGS. 5(a) and 5(b) show input devices and display images according to an embodiment of the present invention, and FIG. 5(c) shows an input device and a display image according to a comparison example.

FIG. 6 is a cross-sectional view showing an electronic device having a touch panel as modification examples of Embodiment 1; FIGS. 6(a) and 6(b) each show different modification examples.

FIG. 7 is a cross-sectional view of an electronic device according to Embodiment 2 of the present invention; FIGS. 7(a) to 7(c) show different forms of the electronic device.

FIG. 8 is a view for explaining an electronic device according to Embodiment 3 of the present invention; FIG. 8(a) is a plan view from the viewer's side, and FIG. 8(b) is a cross-sectional view along the line x-x′ of FIG. 8(a).

FIG. 9 is a cross-sectional view showing a magnified part of the electronic device in FIGS. 8(a) and 8(b).

FIG. 10 is a view for explaining an electronic device according to Embodiment 4 of the present invention; FIG. 10(a) is a plan view from the viewer's side, and FIG. 10(b) is a cross-sectional view along the line x-x′ of FIG. 10(a).

FIG. 11 is a view for explaining a fiber optic faceplate (FOP) of the electronic device of Embodiment 4; FIG. 11(a) is a side view of the arrangement relationship between the camera module and the FOP, and FIG. 11(b) is a cross-sectional view of the FOP.

FIGS. 12(a) and 12(b) are plan views of examples of wiring lines around a hole in the TFT substrate in the electronic device of Embodiment 1.

### DETAILED DESCRIPTION OF EMBODIMENTS

First, the outline of an electronic device according to an embodiment of the present invention will be explained.

The inventors of the present invention diligently researched the arrangement of input devices such as button switches, cameras, and the like in electronic devices having display panels with narrow frame regions. As a result, the inventors concluded that these input devices can be arranged in the display area of the display panel, rather than the frame region, to make it possible to expand the display-capable area without hindering user-friendliness, and that this expanded display-capable area can be effectively used. Arranging the input device in the display area makes it possible to display images on the entire periphery of the panel front surface of the electronic device.

An example of the above-mentioned input device includes an operation button (cross-shaped button or the like) of a portable gaming device, for example. It is preferable, in consideration of user-friendliness, that this type of operation button be provided on the viewer's side surface (panel front surface) of the device. Placing the operation button elsewhere, or reproducing the operation button on a touch panel via software markedly lowers user-friendliness. This is not limited to operation buttons; there is also demand for front surface cameras that capture the user's face or the like to be provided on the panel front surface in order to use the screen during video conferencing or the like.

In this example, the display area on the display panel has a liquid crystal layer, light-emitting diodes, and the like, and a plurality of pixels are provided. A liquid crystal panel, for example, holds a liquid crystal layer in a gap that is sealed by a sealing member disposed on the frame region, and the display area is provided in this gap where this liquid crystal layer is sealed.

Conventionally, input devices, such as those described above, have not been provided in the display area of the display panel. This is because, in many cases, the input device connects to the circuit substrate or the like provided on the rear surface side of the liquid crystal panel, and putting the input device in the display area could pose large difficulties during manufacturing. Furthermore, in conventional electronic devices, the designs are already adapted for a frame region of a certain area; thus, it was not necessary to have an input device in the display area.

In this regard, the research by the inventors of the present invention has shown that it is possible to have a hole penetrating the display panel in the display area of the display panel (in the area defined by the conventional frame region), and connecting the input device through this hole to the circuit substrate on the rear surface of the display panel makes it possible to expand the display area without hindering user-friendliness.

When providing a hole in the liquid crystal panel, for example, the sealing member is disposed on only just the panel periphery, but also around the hole, and forming this hole after the substrates have been bonded together makes it possible to fabricate the liquid crystal panel without significantly affecting other areas. It should be noted that the liquid crystal layer can be formed by, after the sealing member has been disposed on the panel periphery or around the hole, dripping liquid crystal on one substrate before substrate bonding, and then bonding the substrates thereafter, for example. Alternatively, the liquid crystal layer can be formed by providing the sealing member on the panel periphery or around the hole as described above, bonding the substrates together, and then injecting liquid crystal.

A display panel also usually has an array of conductive patterns for driving the pixels. When providing the hole, however, it is difficult to dispose wiring in the vicinity of the hole as would be done for other areas. Yet, it is possible for the wiring to be disposed so as to divert around the hole, and for images or the like to be suitably displayed on the areas except for the hole and around the hole, for example.

As described above, however, when providing a hole in the display panel, a sealing member for sealing the liquid crystal is disposed around the hole. This forms a non-display area around the hole. If this type of non-display area, however, is covered by the input device, then it is possible to obscure the area around the hole. This enables the device to have a sense of coherence.

In addition to covering with the input device, a transmissive cover may be provided on the viewer's side of the display panel, and a lens portion may be disposed on the transmissive cover around the hole. This makes it possible to obscure the non-display area around the hole.

It should be noted that a liquid crystal panel that has a hole in the display area thereof is disclosed in Patent Documents 2 to 4, for example. The display devices described in Patent Documents 2 to 4, however, do not disclose providing the input device in the hole. Furthermore, Patent Documents 2 to 4 do not disclose a configuration that can obscure the area around the hole and provide a sense of coherency between the input device and the display panel.

In an embodiment of the present invention described below, the input device provided on the electronic device may be various types of devices, such as physical/electrical switches or buttons that receive input from a user, an optical device that can receive external light, or the like.

More specifically, the input device includes a push-button, direction key (cross-shaped key), analog stick, touch panel, rotary switch (volume control), rotatable selector (jog dial), toggle switch, trackball, trackpad, stick-type pointing device, hardware keyboard, or the like that can receive input (direct operation) from the user.

In addition, the input device includes an imaging device (CCD image sensor, CMOS image sensor, etc.), light-receiving device (fiber optic faceplate, etc.), optical sensor, or the like that can receive optical input. Furthermore, the input device may be a temperature sensor, microphone, input terminal such as HDMI (registered trademark) or USB, a wiring terminal such as a plug or outlet, or the like.

These input devices are physically, electrically, or optically connected to the circuit substrate disposed on the rear surface side of the display panel. The input from the input device may be processed at the circuit substrate. With this configuration, the display-capable area of the panel surface can be increased while ensuring user-friendliness.

The electronic device of an embodiment of the present invention may be various types of electronic devices, and may be a portable gaming device, smartphone, mobile phone, PDA, tablet terminal, electronic book reader, music player, camera, electronic dictionary, electronic notebook, navigation system, display device, personal computer, wearable computer, game machine, television, information display, or the like, for example.

Embodiments of the present invention are described below with reference to figures, but the present invention is not limited to these embodiments.

### Embodiment 1

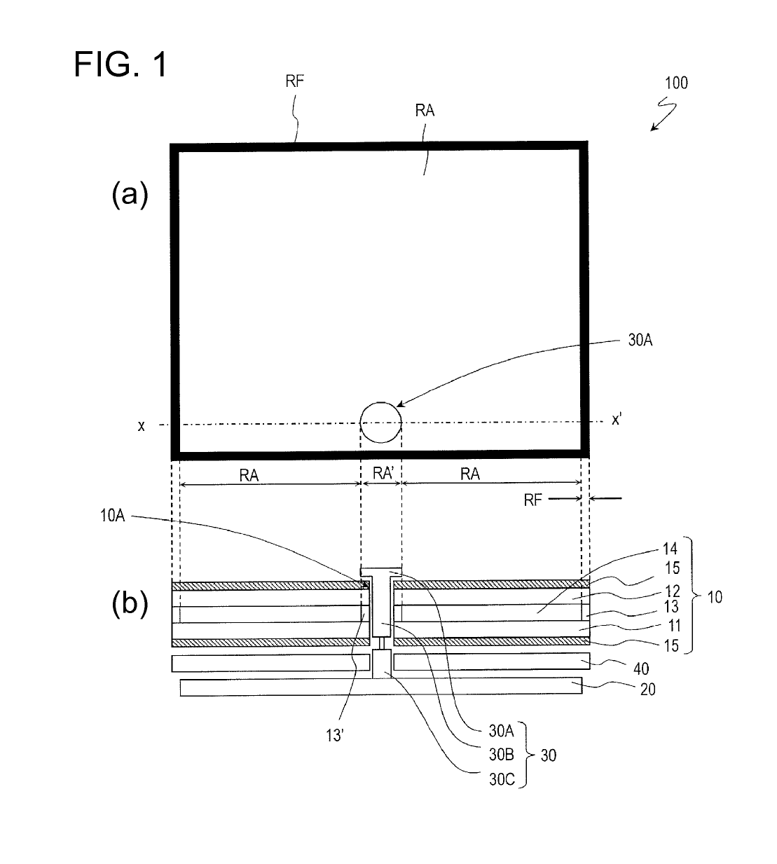

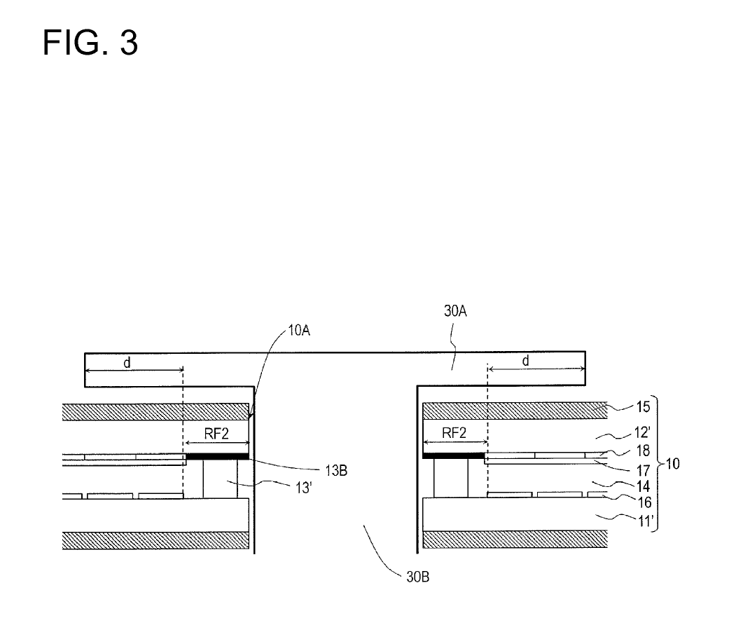

FIG. 1 is a view of a configuration of an electronic device 100 of Embodiment 1; FIG. 1(a) is a plan view as seen from the user, and FIG. 1(b) is a cross-sectional view along the line x-x′ in FIG. 1(a). FIG. 3 is a cross-sectional view of the electronic device 100 in which an area near a hole 10A provided in a display panel 10 has been magnified.

The electronic device 100 of Embodiment 1 includes a liquid crystal panel (the display panel) 10, and a circuit substrate 20 on the rear surface side (opposite to the viewer's side) of the liquid crystal panel 10. The liquid crystal panel 10 of the present embodiment is transmissive, and has a backlight 40 provided between the liquid crystal panel 10 and the circuit substrate 20. The backlight 40 may be an edge-lit backlight that has, in addition to light sources such as LEDs, optical elements such as a light guide plate, diffusion plate, reflective plate, and the like, or the backlight 40 may be a direct-lit (surface-emitting type) backlight.

The liquid crystal panel 10 includes a TFT substrate 11, an opposite substrate 12 that faces the TFT substrate, and a liquid crystal layer 14 held between this pair of substrates. The liquid crystal layer 14 is sealed between the substrates 11 and 12 by a sealing member 13 provided on a peripheral frame region RF, a sealing member 13′ provided around the hole 10A, and the like, as described later.

It should be noted that, as shown in FIG. 3, the TFT substrate 11 has pixel electrodes (transparent electrodes) 16 and the like provided on a transparent substrate 11′. Furthermore, the opposite substrate 12 has a common electrode (transparent electrode) 17, color filter 18, and the like provided on a transparent substrate 12′. On the outer surface of the TFT substrate 11 and the opposite substrate 12, an optical film layer 15 constituted by a polarization plate, phase difference film, or the like is affixed via an adhesive layer. These configurations, however, are merely illustrative, and the liquid crystal panel 10 can have various types of well-known configurations.

Further descriptions will be provided based on FIG. 1. The liquid crystal panel 10 has a display area (active area) RA in which pixels are arrayed, and a frame region RF (hereinafter, also referred to as the “peripheral frame region RF”) outside this display area. It should be noted that, in this example, the area defined within the frame region RF, which is formed on the periphery of the liquid crystal panel 10, is referred to as the “display area RA” for convenience. The display area RA may have areas that do not contribute to display.

In the electronic device 100, the inside of the area defined by the peripheral frame region RF (i.e., the inside of the display area RA) of the liquid crystal panel 10 has a hole 10A that penetrates the liquid crystal panel 10. Furthermore, a non-display area RF2 is formed around the hole 10A. The hole 10A goes through the TFT substrate 11, opposite substrate 12, liquid crystal layer 14, and the like. The hole 10A also penetrates the backlight 40.

It should be noted that the diameter of the hole 10A may be selected as appropriate, but is set at 1 mm to 15 mm, for example. Furthermore, in this example, the planar shape of the hole 10A is illustratively shown as round, but may be any planar shape such as a square or the like.

The hole 10A is provided in the display area RA, but has no pixels, and is thus an area that does not contribute to display. The annular non-display area RF2, which includes the sealing member 13′, a black-matrix (not shown), and the like, is formed around the hole 10A. This non-display area RF2 is also provided in the display area (active area) RA defined by the frame region RF, but does not contribute to display.

In addition, the electronic device 100 has an input device 30 disposed so as to go through the hole 10A in the display area RA. The input device 30, in the present embodiment, is a push-type electric switch, which corresponds to a hardware button provided on a smartphone, for example.

The input device 30 is described in more detail below.

In the electronic device 100, the input device 30 has a front part (switch cap) 30A that protrudes from the viewer's side surface of the liquid crystal panel 10, and an elongated part 30B connected with the front part 30A and disposed inside the hole 10A in the liquid crystal panel 10. The input device 30 also has a connector part 30C provided on the circuit substrate 20. In this type of configuration, the input device 30 is connected to the circuit substrate 20 via the connector part 30C.

In regards to the input device 30, the front part 30A on the user's (viewer's) side is provided as a wide-width part that has a greater radius than the aperture radius of the hole 10A. The front part 30A covers the hole 10A and the non-display area RF2 around the hole 10A.

The input device 30, due to having the wide-width part that has a greater radius than the aperture radius of the hole 10A, may be hard to mount on the circuit substrate if the front part 30A is not connected to the elongated part 30B, as described above. When connected, after the elongated part 30B is mounted on the circuit substrate, this part is made to go through the hole 10A in the liquid crystal panel to secure the front part 30A, thereby allowing for easy assembly.

FIG. 3 is a magnified view around the front part 30A. As shown in FIG. 3, on the liquid crystal panel 10, the non-display area RF2 around the hole 10A includes the sealing member 13′ around the hole and a light-shielding region (black-matrix) 13B for preventing light leakage. The light-shielding region 13B is made of a black resin or the like, and is thus easy to see. Accordingly, it is preferable that the front part 30A be formed so as to hide the non-display area RF2, which includes the sealing member 13′, the light-shielding region 13B, and the like from the user.

In the present embodiment, the front part 30A is formed to cover a distance (tolerance) d from the non-display area RF2 to the outer regions. This allows for the non-display area RF2 to be more reliably covered by the front part 30A in the manufacturing process even if positional deviations between the non-display area RF2 and the front part 30A or dimensional deviations of the front part 30A occur. The distance d is set to approximately 0.1 mm, for example. It should be noted that the non-display area RF2 is strictly defined as the area between the pixel electrodes 16 opposing each other across the hole 10A.

The TFT substrate 11 has a matrix driver circuit including TFTs (not shown), pixel electrodes 16, and the like formed thereon. The opposite substrate 12 has a common electrode 17, color filter 18, and the like formed thereon. The liquid crystal panel 10 of the present embodiment has the hole 10A therein, and as shown in Patent Document 3, for example, the matrix wiring lines around the hole 10A may be formed so as be diverted around the hole 10A.

When the wiring is formed to be diverted around the hole 10A in this manner, the wiring pitch often becomes narrowed. Furthermore, in this area, the aperture ratio may be reduced. Accordingly, the front part 30A may be provided so as to cover a portion of at least the area with the narrow wiring pitch (also referred to as the “separate wiring area”). This makes it possible to concentrate all the areas that are difficult to use for display in one location and to obscure this location with the front part 30A.

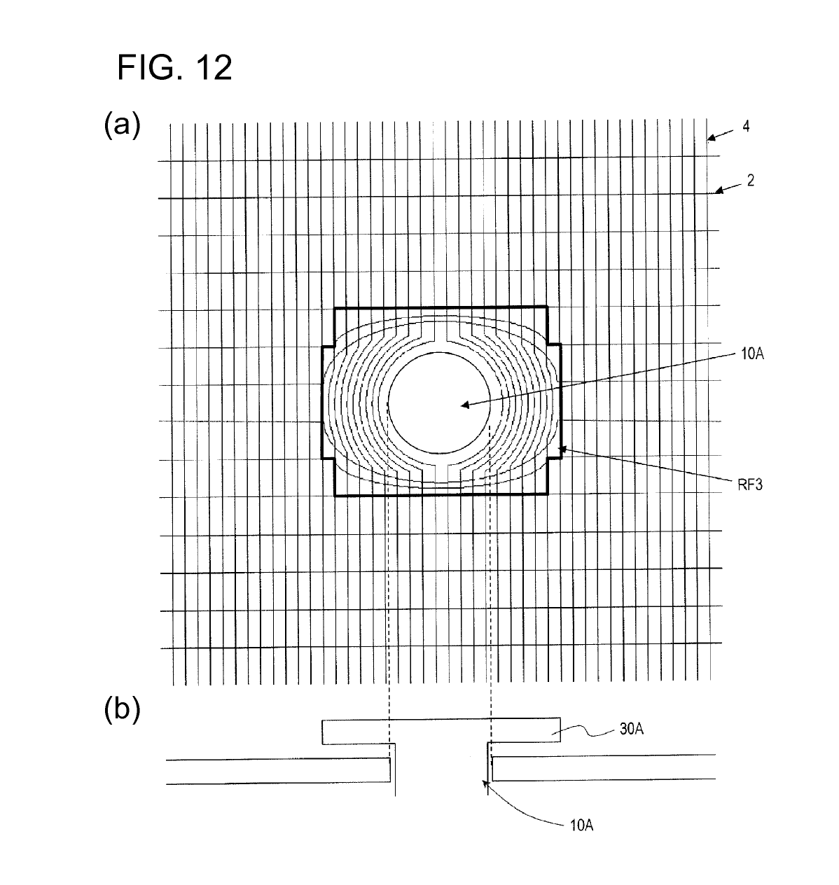

FIG. 12(a) shows one example of wiring on the TFT substrate around the hole 10A. As shown in FIG. 12(a), in the area around the hole 10A, vertically-extending source wiring 4 and horizontally-extending gate wiring 2 that is perpendicular to the source wiring 4 are both provided so as to go around the hole 10A. In this configuration, pixels can be arranged in a matrix in the areas other than around the hole 10A, and using the source wiring 4 or gate wiring 2 to apply a prescribed voltage to the pixel electrodes 16 (see drawing) connected to the TFTs (not shown) allows for an image or the like to be displayed. It should be noted that the TFTs may have the channel thereof formed from an oxide semiconductor layer such as an In—Ga—Zn—O semiconductor layer.

As shown in FIG. 12(a), however, the separate wiring region RF3, which includes the diverted wiring, is provided around the hole 10A. The separate wiring region RF3 has a low aperture ratio and it is difficult to provide pixels in this area. The separate wiring region RF3 cannot be used for display; thus, the separate wiring region RF3 may be covered with a black-matrix.

Furthermore, as shown in FIG. 12(b), in the electronic device 100 of the present embodiment, the separate wiring region RF3 is covered by the front part 30A of the input device 30. This makes it possible to hide the separate wiring region RF3 from the user, thereby allowing a sense of coherency between the front part 30A and the display area RA to be provided to the user.

If the front part 30A covers the non-display area RF2, separate wiring region, and the like in this manner, the user will see a surface RA′ of the front part 30A (see FIG. 1) around the hole, and will not see the non-display area RF2. Accordingly, the input device 30 provided in the display area RA can have a sense of coherency with the display panel 10.

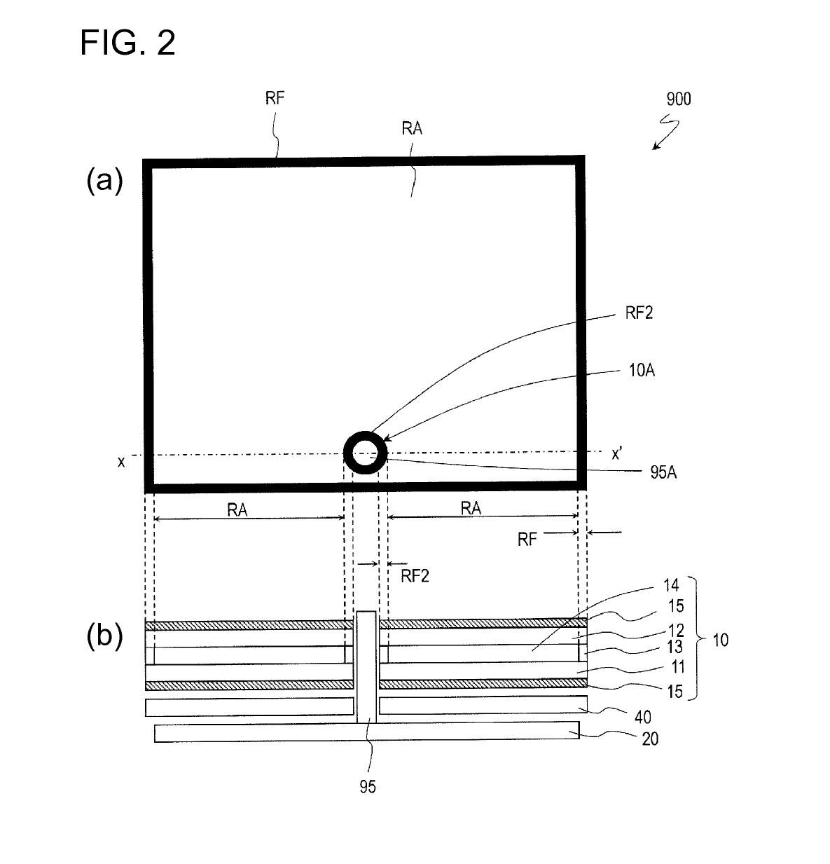

FIG. 2 is a view of a configuration of an electronic device 900 according to a comparison example; FIG. 2(a) is a plan view when seen from the viewer's side, and FIG. 2(b) is a cross-sectional view along the line x-x′ in FIG. 2(a). In FIG. 2, the same reference characters are used for the same constituting elements as the electronic device 900 in FIG. 1, and repetitive descriptions thereof are omitted.

As shown in FIG. 2(b), the liquid crystal panel 10 of the electronic device 900 also has the hole 10A and the non-display area RF2 formed in a looped shape around the hole. In this example, when the non-display area RF2 is visible to the viewer, this portion of the display panel is easy to see. Thus, compared to the electronic device 100 of Embodiment 1, the sense of coherency between the input device and the display panel is harmed.

In particular, if the width of the non-display area RF2 is greater than the width of the peripheral frame region RF, then the non-display area RF2 will stand out, and thus it is preferable to hide the non-display area. It should be noted that the reason the width of the non-display area RF2 would become greater is that, around the hole 10A, it is difficult to provide pixels due to forming the wiring lines so as to be diverted around the hole, and this is sometimes covered with a black-matrix.

The electronic device 100 of Embodiment 1 will again be described.

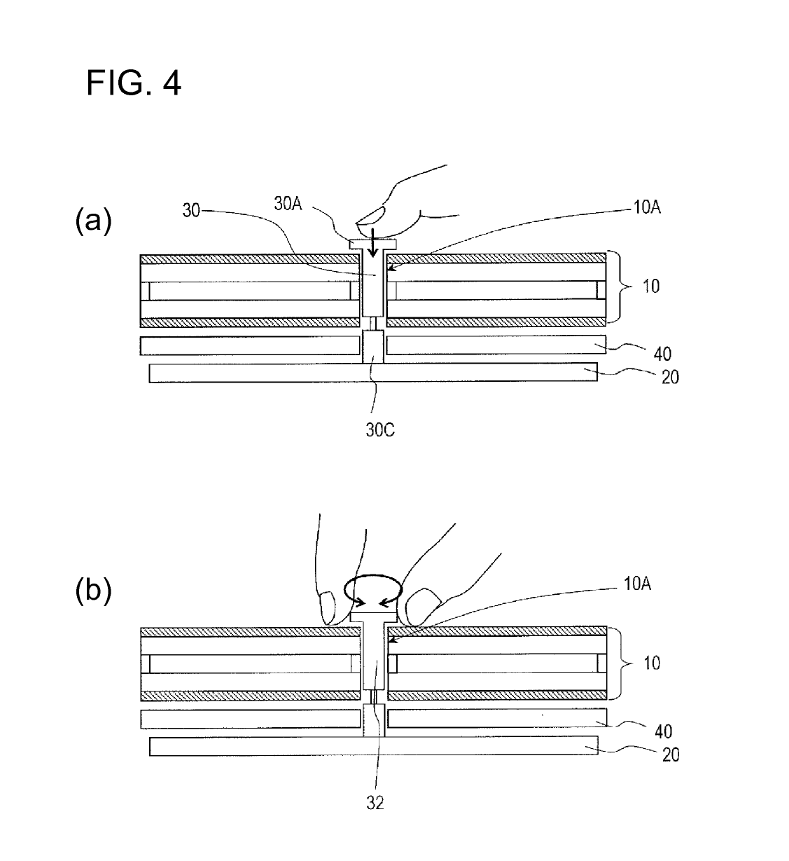

FIG. 4(a) is an in-use view of the input device 30, and this example shows a push-button switch 30 being used as the input device. The user can push the button (i.e., the front part 30A of the switch 30) provided in the display area RA. Pushing this button 30A makes it possible to determine that input (pushing of the button) has occurred by electrical contacts in the connector part 30C on the circuit substrate 20 connecting with one another. It should be noted that a well-known configuration can be used for the push-button switch, and thus a detailed explanation thereof will not be provided.

FIG. 4(b) is an in-use view of a rotary switch 32 as the input device. The user can turn the rotary switch 32, which is disposed in the display area and connected to the circuit substrate 20 through the hole 10A. The turning of this switch may be received as an electrical signal at the connector part on the circuit substrate 20. It should be noted that a well-known configuration can be used for the rotary switch 32, and thus a detailed explanation thereof will not be provided.

Hereinafter, an example is described in which images related to the input device are displayed in the display area of the display panel (the area around the hole and the input device, for example).

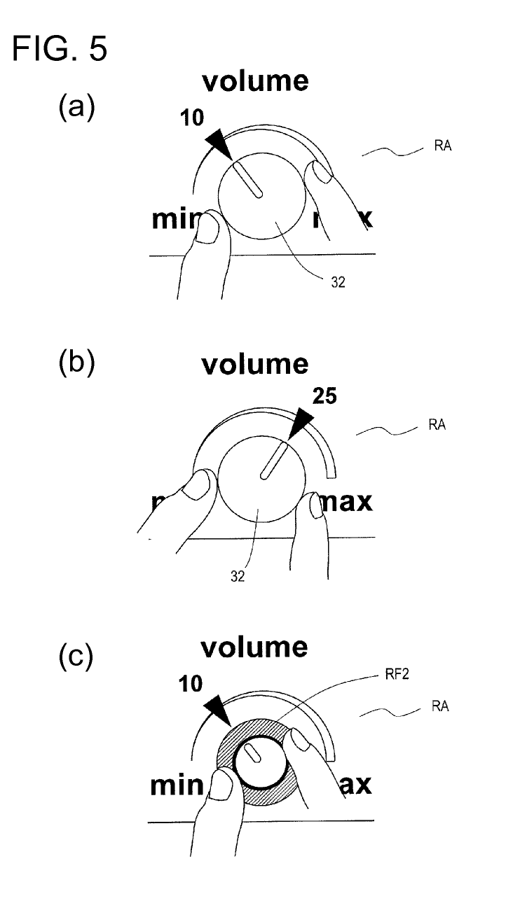

FIGS. 5(a) to 5(c) show the rotary switch 32 as the input device provided in the display area RA.

As shown in FIGS. 5(a) and 5(b), the electronic device according to an embodiment of the present invention may display images or data related to the rotary switch 32 on the display area RA. If the rotary switch 32 is functioning as volume control, for example, the electronic device may display the current audio volume around the rotary switch 32 in response to user operation of the rotary switch 32.

In this manner, displaying images related to the input device makes it possible to provide an experience to the user in which the input device and the display panel operate in integration with one another. Furthermore, appropriately modifying and displaying the data that is important to the user based on operation of the input device enhances user-friendliness. Moreover, it is possible to allow the user to recognize the current function of the input device by the image on the display panel, which is advantageous in that the input device can be used for many purposes with ease.

FIG. 5(c) shows an electronic device of a comparison example. In this electronic device, a rotary switch protruding from the display panel does not cover the non-display area RF2 around the hole. In such a case, the non-display area RF2 between the image that is displayed on the display area RA and the switch is visible to the user. Therefore, operation is less intuitive to the user than the examples shown in FIGS. 5(a) and 5(b). Furthermore, the sense of coherence between the switch and the image suffers.

It should be noted that, as described above, in order to display images related to the input device around the input device on the display panel, it is possible to use a well-known image processing device (imaging processing unit) or the like. The image processing device may include a computation processing unit, a graphic processing unit, or the like provided on the circuit substrate, for example. The image processing device can generate image data that define the image to be displayed on the display panel, and these data can be controlled as appropriate to cause the relevant images to be displayed around the input device.

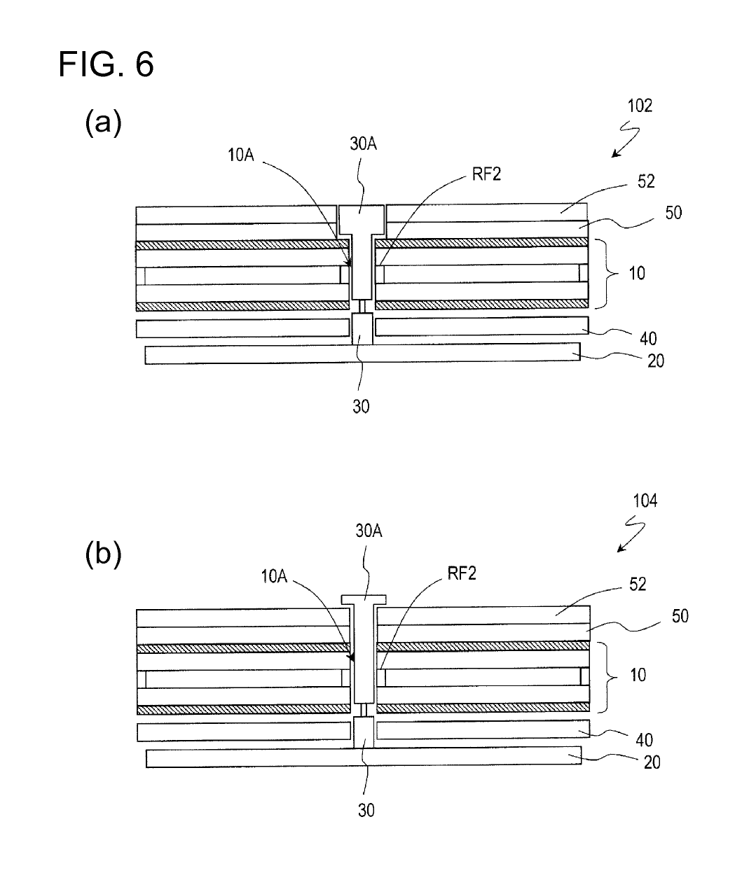

FIGS. 6(a) and 6(b) show electronic devices 102 and 104 of a modification example. A touch panel 50 and a transmissive cover (front plate) 52 are provided on the viewer's side of the display panel 10 of these electronic devices 102 and 104. The touch panel 50 may have a well-known configuration. Furthermore, the transmissive cover 52 is typically made of transmissive glass or a resin material. It should be noted that the transmissive cover 52 and the touch panel 50 may be formed in integration with one another.

As shown in the electronic device 102 in FIG. 6(a), the front part 30A of the input device 30 protrudes from the user-side surface of the display panel 10. The surface of the front part 30A, however, is at approximately the same level as the surface of the transmissive cover 52. This type of configuration is aesthetically pleasing due to the lessened susceptibility of recesses or protrusions in the user-side surface of the electronic device 102. Furthermore, if the input device 30 is a push-button, this type of configuration can lower the possibility of the switch being accidentally pushed. In this manner, the frontmost surface of the transmissive cover 52 being flat is aesthetically preferable, and is suitable for an electronic device for which being thin is of particular importance, such as for mobile phones, smart phones, tablets, or the like.

As shown in the electronic device 104 in FIG. 6(b), the front part 30A of the input device 30 protrudes from the surface of the touch panel 50 and the transmissive cover 52, rather than from the user-side surface of the display panel 10. If the input device 30 is a rotary switch or the like, this type of configuration would be more of an improvement in user-friendliness.

In either of the above cases, it is preferable that the front part 30A of the input device 30 cover the non-display area RF2 around the hole 10A. This can obscure the hole 10A and give a sense of coherency between the input device 30 and the display panel 10.

It should be noted that, as shown in FIGS. 6(a) and 6(b), when providing the input device 30, the respective holes in the touch panel 50 and the transmissive cover 52 typically correspond to each other. As described later, however, if the input device 30 does not require direct user input, such as if the device is a light-receiving device, then the touch panel 50 and the transmissive cover 52 do not need to have holes and may cover the front part 30A of the input device 30 instead.

Furthermore, as shown in FIGS. 6(a) and 6(b), an example is shown in which an Out-Cell touch panel 50 is provided on the viewer's side of the display panel 10, but the present embodiment is not limited to this. It is possible to use an On-Cell or In-Cell touch panel instead of the Out-Cell touch panel 50. If using an In-Cell touch panel, the touch panel is configured inside the display panel 10.

As described above, in the electronic device of the present embodiment, an input device such as a switch can hide the non-display area (which includes the sealing member, areas with no pixel electrodes, and gaps between the components and the display panel) on the display panel, thereby allowing the switch to blend in seamlessly with the display screen. Furthermore, linking the switch operation and the image is advantageous in that ease-of-use for the user is markedly enhanced and in that a wide range of operations are possible with only a small number of switches.

### Embodiment 2

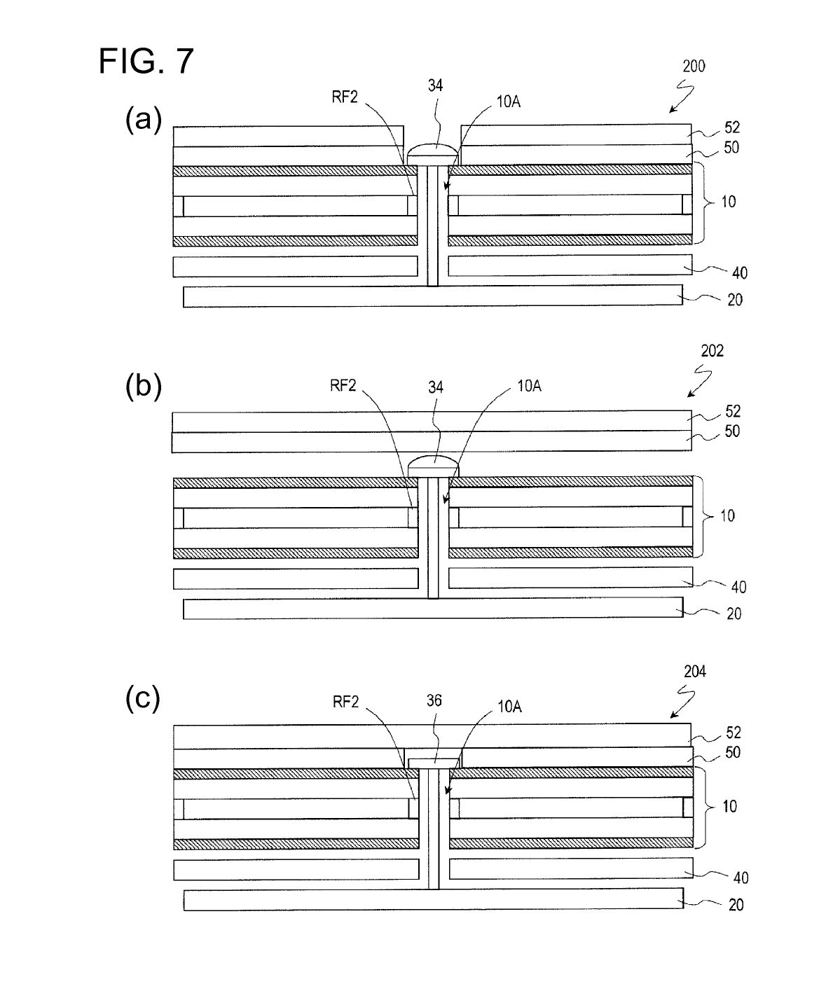

FIG. 7(a) is a cross-sectional view of an electronic device 200 of Embodiment 2. FIGS. 7(b) and 7(c) are cross-sectional views of different modification examples 202 and 204. The electronic devices 200, 202, and 204 of Embodiment 2 differ from the electronic device 100 of Embodiment 1 in that an optical device is provided as the input device. The same reference characters are used for the same constituting elements in Embodiment 1, and repetitive descriptions thereof are omitted.

The electronic device 200 shown in FIG. 7(a) includes a display panel 10, backlight 40, and circuit substrate 20. In a similar manner to the electronic device 100 of Embodiment 1, a hole 10A that penetrates the substrate is provided in the display area of the display panel 10.

In the electronic device 200, a camera module (imaging device) 34 is disposed at a location corresponding to the hole 10A. The camera module 34 protrudes from the viewer's side surface of the display panel 10 and covers the non-display area RF2 around the hole formed in the display panel 10. It is preferable that the camera module 34 protrude above the surface of the display panel 10 in order to improve sensitivity and widen the viewing angles thereof to make it easier to capture light and the like.

In the electronic device 200, in a similar manner to the examples in FIGS. 6(a) and 6(b), the touch panel 50 and the transmissive cover 52 are arranged on the viewer's side of the display panel 10. Respective holes are disposed in the touch panel 50 and the transmissive cover 52 in positions corresponding to the hole 10A and the camera module 34. The camera module 34 is exposed in these holes.

If the touch panel 50 and the transmissive cover 52 have sufficient transmittance, however, then as shown in FIG. 7(b), the touch panel 50 and the transmissive cover 52 of the electronic device 202 do not need to have holes, and may cover the camera module 34 instead, for example.

Furthermore, as shown in FIG. 7(c), the electronic device 204 may have various types of optical sensors as the input device, and is not limited to the camera module. The optical sensors can be light sensors, proximity sensors, or the like. Light sensors are used for adjusting screen brightness in accordance with ambient light or the like. Proximity sensors are used for identifying if entities are nearby.

Even if the camera module 34 or the optical sensor 36 is provided, as is the case with the respective electronic devices 200, 202, and 204 shown in FIGS. 7(a) to 7(c), the non-display area RF2 can be covered with the input devices 34 and 36 disposed on the front surface of the display panel, thereby making it possible to obscure the hole 10A. This makes it possible to provide an electronic device having a sense of coherency.

Furthermore, in the present embodiment, the input devices (optical devices) 34 and 36 are connected to the circuit substrate 20 disposed on the rear surface side of the display panel 10 via the connector part. The circuit substrate 20 may be configured to be able to generate image data, light data, or the like in accordance with input signals from the optical devices 34 and 36.

It should be noted that, in the electronic devices 200, 202, and 204 of the present embodiment, images related to the input device may be displayed on the display panel 10. If provided with the camera module 34, then software may be included whereby a camera start button or the like is displayed in the immediate vicinity of the camera module 34 and touching this displayed area on the touch panel starts the camera, for example. In such a case, the linking of the camera module and the display image allows for more intuitive operation by the user. Furthermore, if providing the touch panel on the camera module, the software may start the camera when the area above the camera module is touched, which allows connection between the camera module and the touch panel.

In a similar manner, it is preferable that the adjusting of the light sensors and the like be possible in conjunction with the images displayed on the display panel. The device may be configured such that screen brightness is adjusted by the user touching an area near the light sensor on the touch panel, for example.

It should be noted that the dispersion and the like of the light by the electrodes in the touch panel may adversely affect the camera module or sensors, and in such a case, the device may be designed such that the electrodes or the like are not arranged in areas corresponding to above the camera or sensors.

### Embodiment 3

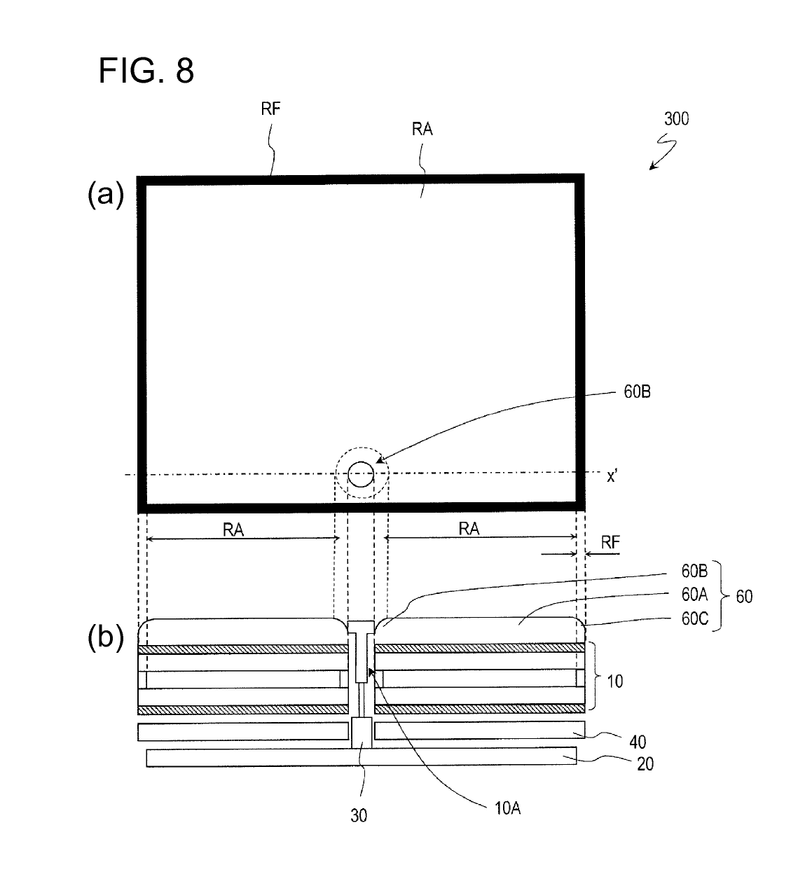

FIG. 8 is a view of an electronic device 300 of Embodiment 3; FIG. 8(a) is a plan view when seen from the user's side, and FIG. 8(b) is a cross-sectional view along the line x-x′ of FIG. 8(a).

As shown in FIGS. 8(a) and 8(b), the electronic device 300 also has the hole 10A in the display panel 10, and the input device 30 (in this example, a push-button switch) in a location corresponding to the hole 10A. The input device 30 is connected to the circuit substrate 20. The same reference characters are used for the same constituting elements in Embodiment 1, and repetitive descriptions thereof are omitted.

In the electronic device 300, a transmissive cover 60 is provided on the viewer's side of the display panel 10. The transmissive cover 60 is made of a transmissive material such as glass or plastic and allows light from the display panel 10 to pass through to the viewer's side.

The transmissive cover 60 also has a hole in a location corresponding to the hole 10A in the display panel 10. Furthermore, in the area around the hole 10A in the display panel 10, the transmissive cover 60 has a curved portion on the surface thereof. This curved portion functions as a lens portion 60B. It should be noted that a flat portion 60A is disposed around the lens portion 60B, and most of the display panel 10 is covered by the flat portion 60A. The transmissive cover 60, however, has a separate lens portion (peripheral lens portion) 60C corresponding to the periphery (i.e., area where the frame region RF is formed) of the display panel 10.

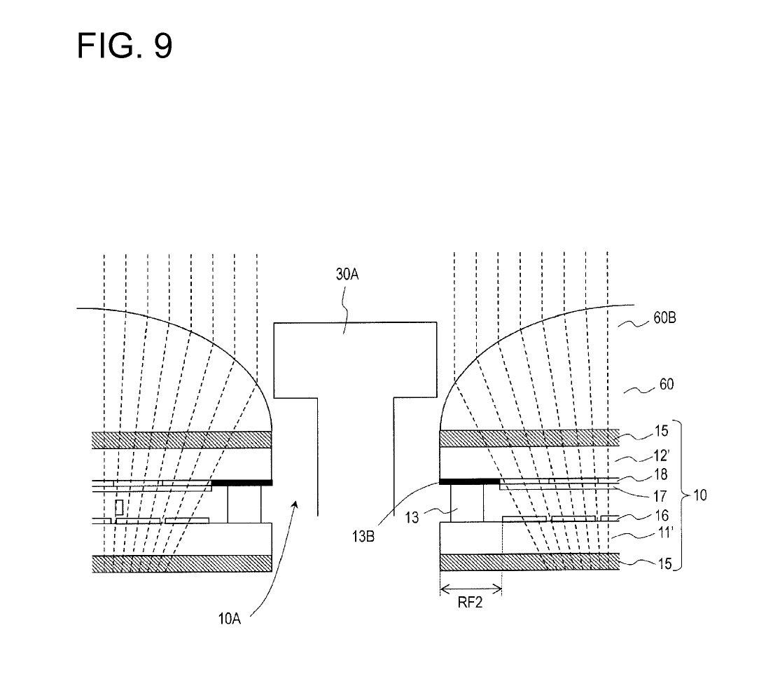

FIG. 9 is a view for explaining the effects of the lens portion 60B provided near the hole 10A. It should be noted that, in FIG. 9, the optical paths of the light that passes through the display panel 10 and is then emitted from the surface of the transmissive cover 60 are shown by the dotted lines. As can be understood from FIG. 9, in the electronic device 300, the lens portion 60B is provided on the transmissive cover 60, and thus the light emitted from the pixel areas near the non-frame region RF2 refract at the lens portion 60B (in this example, the user-side surface of the lens portion 60B). This enlarges the image formed by the pixels located around the hole 10A and displays the image on the front surface of the non-display area RF2. Accordingly, merely providing the lens portion 60 around the hole 10A makes it possible to obscure the non-frame region RF2, which allows the user to feel a sense of coherency between the input device 30 and the display panel 10.

In this example, the shape of the curved lens surface of the lens portion 60B (more specifically, the curved line formed by the curved lens surface in a cross section) is expressed by the following formula, where R1 is the curvature radius (or c is the curvature) and k is the aspheric coefficient (conic constant), for example.

f(x)=Y−cx²/(1+(1−(1+k)c²x²)^{1/2}) Aspheric formula

In the above formula, c=1/R1, x is the horizontal distance from the top of the lens (the boundary of the lens portion 60B and the flat portion 60A), and Y is the height at the top of the lens (the thickness of the transmissive cover 60 on the flat portion 60A). The curvature radius R1, conic constant k, thickness of the transmissive cover 60, and the like may be set in accordance with the width of the non-display area RF2 or the like.

A more specific shape for the lens portion 60B is described in detail in WO 2009/157150 and WO 2010/070871. The lens surface shape described in the above-mentioned documents can also be applied to the embodiments of the present invention. The contents of WO 2009/157150 and WO 2010/070871 are incorporated in the present specification by reference.

It is preferable that the shape of the lens portion 60B around the hole 10A be part of a rotating member, for example. It should be noted that this “rotating member” means a three-dimensional figure obtained by rotating the plan view figure 360° around a straight line that is positioned in the same plane thereof. In the present embodiment, the lens portion 60 may have a shape including a rotating member in which a plan view figure thereof is disposed in a location separated from the rotational axis, and the rotating member itself is obtained by causing the plan view figure thereof having the curved line segment on the rotational axis-side to rotate.

Furthermore, the shape of the lens portion is not limited to the example in FIG. 9 in which one side of the lens portion is a convex lens. The lens may be formed as a Fresnel lens, for example. Moreover, both the viewer's side front surface and rear surface may be formed so as to have convex curves. The transmissive cover may be various types of shapes, as long as the cover has the lens portion. The transmissive cover may be a shape that has a lens portion provided around the hole 10A and a slanted portion that slants towards the surface of the display panel from the lens portion, thereby selectively covering only the area around the hole 10A, for example. It should be noted that, in the present specification, even in such a configuration that selectively covers the area around the hole 10, this member is still referred to as a “transmissive cover.”

Furthermore, in the electronic device 300 of the present embodiment, the separate lens portion 60C is disposed in the peripheral frame region RF. Therefore, in a similar manner to the images being able to be displayed around the hole 10A, images can also be displayed on the peripheral frame region RF around the display panel 10. Accordingly, all areas of the panel front surface of the electronic device 300 except where the input device is disposed can be used as areas capable of image display.

It should be noted that the examples shown in FIGS. 8 and 9 differ from the electronic device 100 of Embodiment 1 in that the front part 30A of the input device 30 does not cover the non-frame region RF2 formed around the hole in the display panel 10. However, even if a transmissive cover having a lens portion is provided, as in the electronic device of the present embodiment, the front part 30A of the input device 30 may cover part or all of the non-frame region RF2. The array pitch of the pixels around the hole 10A may be configured to be smaller than the array pitch of the center pixels, and display may be performed by light from the peripheral pixels being expanded at the lens portion 60B and displayed. Making the pixel pitch of the peripheral pixels smaller is suitable for a case in which the gaps between wiring lines around the hole 10A are narrow, or the like.

### Embodiment 4

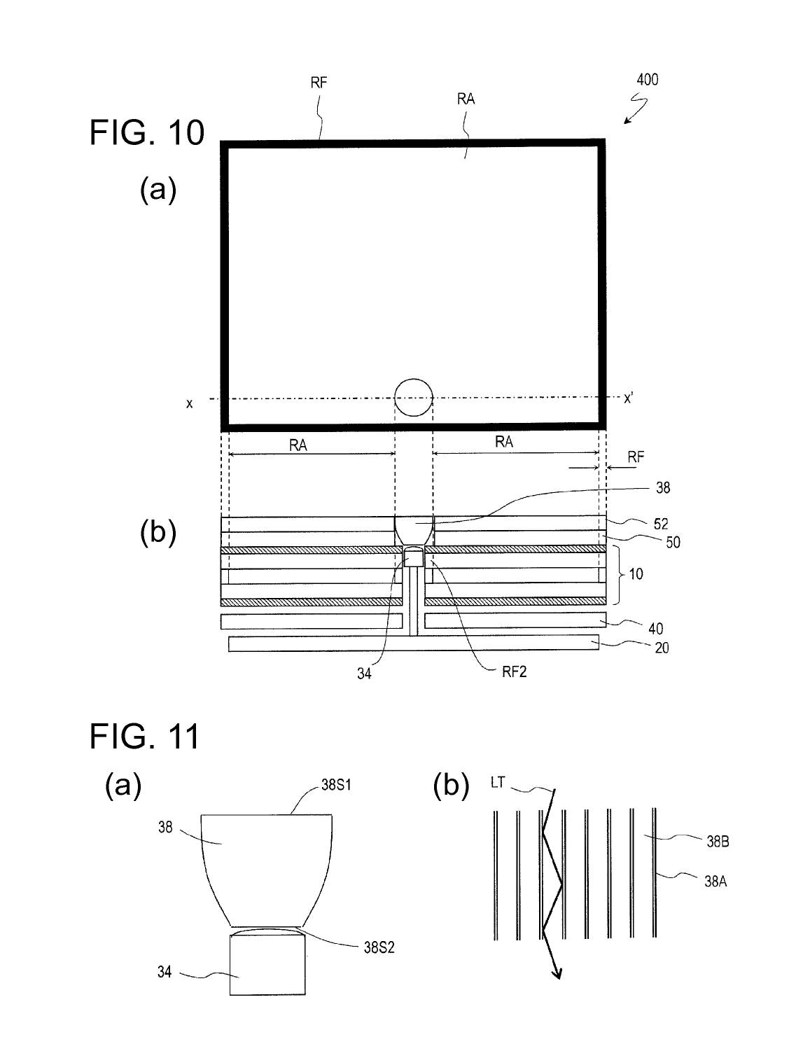

FIG. 10 is a view of an electronic device 400 of Embodiment 4; FIG. 10(a) is a plan view seen from the viewer's side, and FIG. 10(b) is a cross-sectional view along the line x-x′ of FIG. 10(a). In the electronic device 400, a hole 10A is provided in a display panel 10, and input devices 34 and 38 are disposed in locations corresponding to the hole 10A. The input devices 34 and 38 are connected to a circuit substrate 20. The same reference characters are used for the same constituting elements in Embodiment 1, and repetitive descriptions thereof are omitted.

The electronic device 400 includes, as the input devices 34 and 38, a camera module 34, and a fiber optic faceplate (FOP) 38 disposed on the viewer's side of the camera module 34.

The camera module 34 is provided inside the hole 10A in the display panel 10. Meanwhile, the fiber optic faceplate 38 is provided in a location that protrudes from the viewer's side surface of the display panel 10.

The electronic device 400 also has a touch panel 50 and a transmissive cover 52. The touch panel 50 and the transmissive cover 52 have holes therein at locations corresponding to the hole 10A in the display panel. The fiber optic faceplate 38 is provided inside the respective holes in the touch panel 50 and the transmissive cover 52. This makes it possible for the viewer's side surface of the device 400 to be flat, which enhances the aesthetics of the device.

FIG. 11(a) shows the fiber optic faceplate 38 and the camera module 34. As shown in FIG. 11(a), the fiber optic faceplate 38 has a tapered shape. More specifically, the fiber optic faceplate 38 has a shape in which the area of an end face 38S 1 of the faceplate on the viewer's side is greater than the area of an end face 38S2 on the camera module 34 side of the faceplate. The use of this tapered fiber optic faceplate 38 allows the camera module 34 to be housed inside the hole 10A in the display panel 10 and allows the fiber optic faceplate 38, which is disposed outside the display panel 10, to cover the non-display area RF2.

It should be noted that, as shown in FIG. 11(b), the fiber optic faceplate 38 is formed by bundling a plurality of optical fibers each having a core layer 38A and a cladding layer 38B outside the core layer 38A. The refractive index of the cladding layer 38B is typically lower than the refractive index of the core layer 38A, and light LT that has entered from the viewer's side end face 38S 1 by exceeding the critical angle is repeatedly reflected at the boundary while being propagated inside the core layer 38A, and this light exits from the end face 38S2 on the camera module 34 side of the fiber optic faceplate. This allows external light to enter the camera module 34 via the fiber optic faceplate 38.

In the tapered fiber optic faceplate 38, the radius of the optical fibers gradually changes along the thickness direction of the faceplate. With this configuration, light can be propagated by diffusing/concentrating the light without attenuation. The tapered faceplate is described in Japanese Patent Laid-Open Publication No. H8-338916, for example.

Embodiments of the present invention were described above, but it is apparent that various modifications can be made. An example was described in which a liquid crystal panel is used as the display panel, but the present invention is not limited to this, for example. The display panel can be an organic EL display, plasma display panel, electrophoretic display panel, electro-wetting display panel, or the like. When using a self-luminous display panel such as an organic LE display, a backlight is not necessary.

The input device 30 described above may include a detachable section. The input device 30 may be constituted by an operating section that is arranged in the hole 10A in the display panel 10 and that is connected to the circuit substrate 20, and a stick section that can attach to and detach from the operating section, for example. The surface of the operating section can have fitting holes or screw holes therein, and the user can insert or screw in the stick section to these fitting holes as necessary, and use the stick section as an input device such as an analog stick, for example.

The present specification discloses an electronic device as described below.

[Item 1]

An electronic device, including: a display panel having a substrate, the display panel having a display area on the substrate, a frame region on the substrate outside the display area, a hole that penetrates the substrate in an area defined by the frame region, and a non-display area around the hole; an input device disposed on one side of the substrate and having a section protruding from the display panel, the input device being disposed in a location corresponding to the hole; and a circuit substrate on another side of the substrate, wherein the input device is connected to the circuit substrate via the hole in the display panel.

In the electronic device described in item 1, the input device is provided in a location corresponding to the hole in the display area of the display panel, which makes it possible to have a narrower frame region without hindering user-friendliness.

[Item 2]

The electronic device described in item 1, in which the input device at least partially covers the non-display area formed around the hole.

The electronic device described in item 2 makes it possible to obscure the non-display area formed around the hole.

[Item 3]

The electronic device described in item 3 is the electronic device described in item 2, in which a separate wiring region having a different wiring pattern from other regions is formed around the hole; the non-display area includes the separate wiring region; and the input device at least partially covers the separate wiring region.

The electronic device described in item 3 makes it possible to obscure the separate wiring included in the non-display area formed around the hole.

[Item 4]

The electronic device described in any one of items 1 to 3, in which the electronic device further includes a transmissive cover that covers at least a portion of the display panel, and the transmissive cover includes a lens section having a curved surface around the hole.

The electronic device described in item 4 makes it possible to obscure the non-display area formed around the hole with the lens portion.

[Item 5]

The electronic device described in item 5 is the electronic device described in item 4, in which the transmissive cover covers at least the area around the hole in the display panel and has a separate lens portion in an area corresponding to the end of the display panel.

The electronic device described in item 5 makes it possible to obscure not just the area around the hole, but also the non-frame area formed on the end of the display panel.

[Item 6]

The electronic device described in item 6 is any one of the electronic devices described in items 1 to 5, in which the display panel has a pair of substrates and a display medium layer held between the pair of substrates, and a sealing member for sealing the space between the pair of substrates provided in the non-display area formed around the hole.

The electronic device described in item 6 has the sealing member provided around the hole, which can reduce adverse effects on the inside of the display panel.

[Item 7]

The electronic device described in item 7 is the electronic device described in any one of items 1 to 6, in which the input device has a first portion that is larger than the hole and that protrudes from the viewer's side surface of the display panel, and a second portion that is linked to the first portion and that is disposed inside the hole.

The electronic device described in item 7 provides a suitable input device that penetrates the hole.

[Item 8]

The electronic device described in any one of items 1 to 7, in which the electronic device further includes an image processing unit that generates image data supplied to the display panel, and the image processing unit can generate image data to cause an image related to the input device to be displayed around the input device.

The electronic device described in item 8 can link display images to operation of the input device or the like, thereby making it possible to further improve user-friendliness.

[Item 9]

The electronic device described in item 9 is the electronic device described in item 8, in which the images linked to the input device are images for operating the input device.

The electronic device described in item 9 allows the operation of the input device to be performed on the display screen.

[Item 10]

The electronic device described in item 10 is any one of the electronic devices described in items 1 to 9, in which the input device can receive direct operation from the user and in which a signal is supplied to the circuit substrate in accordance with the operation of the user.

The electronic device described in item 10 provides a suitable input device that can receive direction operation from the user.

[Item 11]

The electronic device described in item 11 is any one of the electronic devices described in items 1 to 9, in which the input device is a light-receiving device.

The electronic device described in item 11 provides an input device including a light-receiving device.

[Item 12]

The electronic device described in item 11, in which the input device includes an imaging device and a fiber optic faceplate behind the imaging device.

The electronic device described in item 12 provides a suitable imaging device.

[Item 13]

The electronic device described in item 13 is the electronic device described in item 11, in which the fiber optic faceplate has a tapered shape, and an area of an end face on the viewer's side of the display panel of the faceplate is greater than an area on another end face of the faceplate.

The electronic device described in item 13 can obscure the area around the hole while providing a suitable imaging device.

[Item 14]

The electronic device described in item 14 is the electronic device described in any one of items 1 to 13, in which the display panel is a liquid crystal display panel.

The electronic device described in item 14 can narrow the frame region without hindering user-friendliness even if a liquid crystal display panel is used.

### INDUSTRIAL APPLICABILITY

An electronic device of an embodiment of the present invention is widely used in electronic devices having a display panel, such mobile gaming devices, smartphones, and the like.

### DESCRIPTION OF REFERENCE CHARACTERS

100 electronic device
10 display panel
10A hole
11 TFT substrate
12 color filter substrate
13 seal
14 liquid crystal layer
16 optical film layer
20 circuit substrate
30 input device
40 backlight
RF frame region (non-active area)
RF2 non-display area (area around hole)
RA display area (active area)

1. An electronic device, comprising:
a display panel having a substrate, said display panel having a display area on the substrate, a frame region on the substrate outside said display area, and a hole that penetrates the substrate within the display area, display being inhibited in a portion of the display area that surrounds said hole;
an input device disposed on one side of the substrate and having a section protruding from the display panel, said input device being disposed in a location corresponding to said hole; and
a circuit substrate on another side of the substrate,
wherein the input device is connected to the circuit substrate via the hole in the display panel.

2. The electronic device according to claim 1, wherein the input device at least partially covers said portion of the display area that surrounds the hole.

3. The electronic device according to claim 1, further comprising:
a transmissive cover that covers at least a portion of the display panel,
wherein the transmissive cover includes a lens section having a curved surface around the hole.

4. The electronic device according to claim 1, further comprising:
an image processing unit that generates image data supplied to the display panel,
wherein the image processing unit is configured to generate image data to cause an image related to the input device to be displayed around the input device.

5. The electronic device according to claim 1, wherein the input device includes an imaging device and a fiber optic faceplate behind said imaging device.

6. The electronic device according to claim 2, further comprising:
a transmissive cover that covers at least a portion of the display panel,
wherein the transmissive cover includes a lens section having a curved surface around the hole.

7. The electronic device according to claim 2, further comprising:
an image processing unit that generates image data supplied to the display panel,
wherein the image processing unit is configured to generate image data to cause an image related to the input device to be displayed around the input device.

8. The electronic device according to claim 3, further comprising:
an image processing unit that generates image data supplied to the display panel,
wherein the image processing unit is configured to generate image data to cause an image related to the input device to be displayed around the input device.

9. The electronic device according to claim 6, further comprising:
an image processing unit that generates image data supplied to the display panel,
wherein the image processing unit is configured to generate image data to cause an image related to the input device to be displayed around the input device.

10. The electronic device according to claim 2, wherein the input device includes an imaging device and a fiber optic faceplate behind said imaging device.

11. The electronic device according to claim 3, wherein the input device includes an imaging device and a fiber optic faceplate behind said imaging device.

12. The electronic device according to claim 6, wherein the input device includes an imaging device and a fiber optic faceplate behind said imaging device.

13. The electronic device according to claim 4, wherein the input device includes an imaging device and a fiber optic faceplate behind said imaging device.

14. The electronic device according to claim 7, wherein the input device includes an imaging device and a fiber optic faceplate behind said imaging device.

15. The electronic device according to claim 8, wherein the input device includes an imaging device and a fiber optic faceplate behind said imaging device.

16. The electronic device according to claim 9, wherein the input device includes an imaging device and a fiber optic faceplate behind said imaging device.
